(19) United States
(12) Patent Application Publication
(10) Pub. No.: US 2002/0193713 A1
(43) Pub. Date: Dec. 19, 2002

(54) Massage apparatus

(76) Inventor: Chun-Hsiu Lee, Taoyuan Hsien (TW)

Correspondence Address: DOUGHERTY & TROXELL, SUITE 1404, 5205 LEESBURG PIKE, FALLS CHURCH, VA, 22041, US

(21) Appl. No.: 09/898,051

(22) Filed: Jul. 5, 2001

(30) Foreign Application Priority Data
Jun. 18, 2001 (TW) 90210201

(51) Int. Cl. A61H 7/00

(52) U.S. Cl. 601/99; 601/98

(57) ABSTRACT

A massage apparatus comprises an outer casing set, a chain set, and a prime mover set. The outer casing set is composed of two casings facing to each other with a curve casing wall with a longitudinal curvilinear casing groove respectively. A limit switch is disposed at both ends of the outer casing set. The chain set further comprises two wheel seats, two endless chains, two arm plates, and two pairs of sprockets, and two direction wheels. The wheel seats are disposed at two lateral sides of the outer casing set respectively and at an upper level relative to the outer casing set. Each endless chain fixedly joins with the respective wheel seat. Each arm plate pivotally connects with each wheel seat via a spindle. The respective arm plate provides a stop piece to limit a pivot angle thereof. Each direction wheel is sandwiched between the upper part and the lower part of the casing wall. The sprockets mesh with the endless chains. The prime mover set is a motor and the output of the motor transmits to a transmission shaft via speed reducing gears and direction changing gears. The transmitting shaft at both ends thereof joins with one of the sprockets.

### BACKGROUND OF THE INVENTION

1. Field of The Invention

The present invention relates to a massage apparatus, and, more particularly, to an improved massage apparatus, which is possible to snuggle into the back of a user so as to enhance the effect of relieving the pain in the back.

2. Description of Related Art

A pain in the back is an ordinary symptom we have experienced, especially while we are very tired from work. Usually, a certain physical disorder resulting from ageing may be relieved through a physical way. It is very common in our competitive society that we are subjected to a muscle pain because of a great workload and working hard. In order to reduce the pain, some of us rely on the massage.

For instance, a conventional manual massage is often used for reliving the pain of the back, but, the manual massage has to be restricted by the time and the place suitable for the massager and the person to be massaged. Also, the effect of massage is variable and depends on the professional massage skill of the massager.

In addition, a massage bed is available in the market, which provides a huge size so that the user can lie down thereon for executing the massage job on the back. The massage bed is costly and the user has to lie down boringly as soon as the massage is to be performed. Meanwhile, it is bulk and heavy so that it is only possible to stay at a fixed location without mobility.

### SUMMARY OF THE INVENTION

An object of the present invention is to provide a massage apparatus, which has massage rollers snuggling into and moving back and forth along the back of a user to perform a massage effectively.

### BRIEF DESCRIPTION OF THE DRAWINGS

The present invention can be more fully understood by referencing to the following description and accompanying drawings, in which:

FIG. 1 is an exploded perspective view of a massage apparatus according to the present invention;

FIG. 2 is a perspective view of FIG. 1 after assembling; and

FIG. 3 is a perspective view illustrating the rollers in the massage apparatus of the present invention in a state of actuation.

### DETAILED DESCRIPTION OF THE PREFERRED EMBODIMENTS

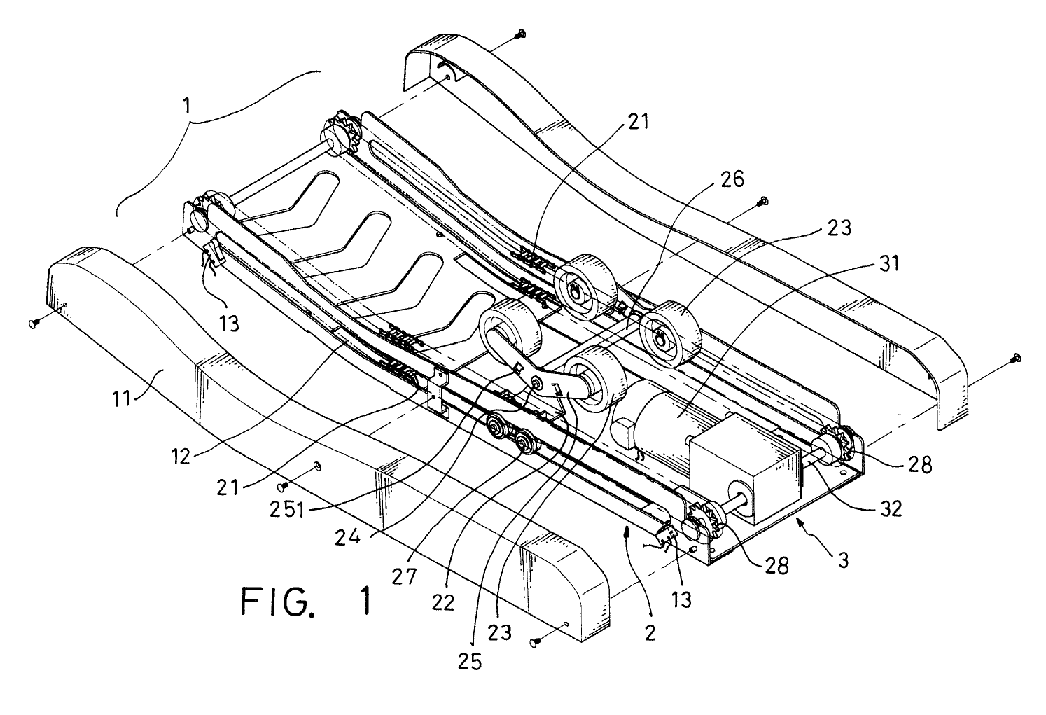

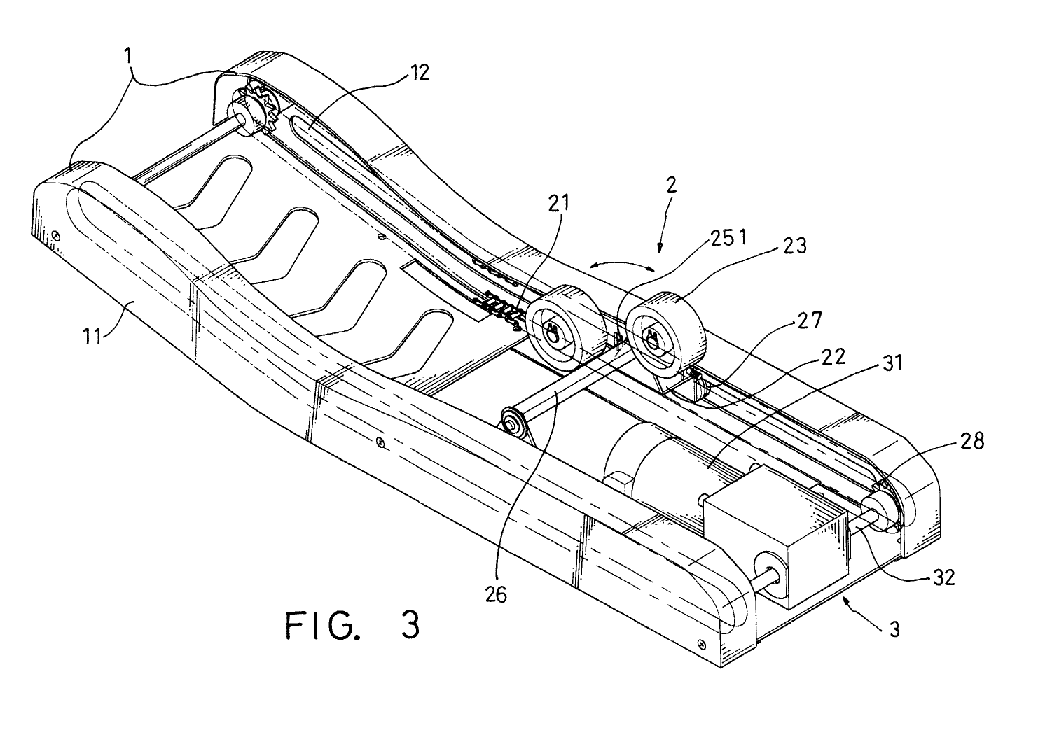

Referring to FIGS. 1 to 3, a massage apparatus according to the present invention basically comprises an outer casing set 1, a chain set 2, and a prime mover set 3.

Wherein, the outer casing set 1 provides a left and a right casings 11 disposed to face to each other, and both of the casings 11 are in conjunction with the sprocket set 2 by way of fasteners such as screws. In order to comply with the contour of the back of a human body, the casings 11 each at the upper part thereof are preferably provided with a curve respectively, and at the center thereof provide a curvilinear groove 12 corresponding to the curve on the top part thereof to guide direction wheels 27 moving along the groove. Besides, one of the casings 11 at the outer side thereof provides a limit switch 13 respectively at both ends thereof to limit the forward movement of the direction wheels 27 and allow the direction wheels moving backward.

The chain set 2 has two chains 21 to fixedly engage with a roller seat 22 respectively and the roller seat 22 is pivotally attached with an arm plate 25 by way of a spindle 24 passing through the arm plate 25. The arm plate at both ends thereof rotatably fixes a group of two massage rollers 23. In order to specify a pivot angle for the movement of the arm plate 25 with respect to the roller seat 22, the arm plate 25 may provide an outward projection 251 integrally. Moreover, a transverse positioning rod 26 at both ends thereof is arranged to connect with the two roller seats 22 such that the roller seats 22 can move back and forth synchronously.

In order to keep an undeviating moving direction, at least a set of the direction wheels 27 is arranged corresponding to the curvilinear groove 12 and joined to the wheel seat 22 so as to be sandwiched between an upper and a lower casing plate on the curvilinear groove 12 such that it is possible for the direction wheels 27 to slide along the curvilinear groove 12 during being actuated.

Besides, each chain 21 is driven by two sprockets 28 disposed at both ends of the casing 11 and the chain 21 is preferably arranged to enclose the sprockets 28 in a state of slightly loosening.

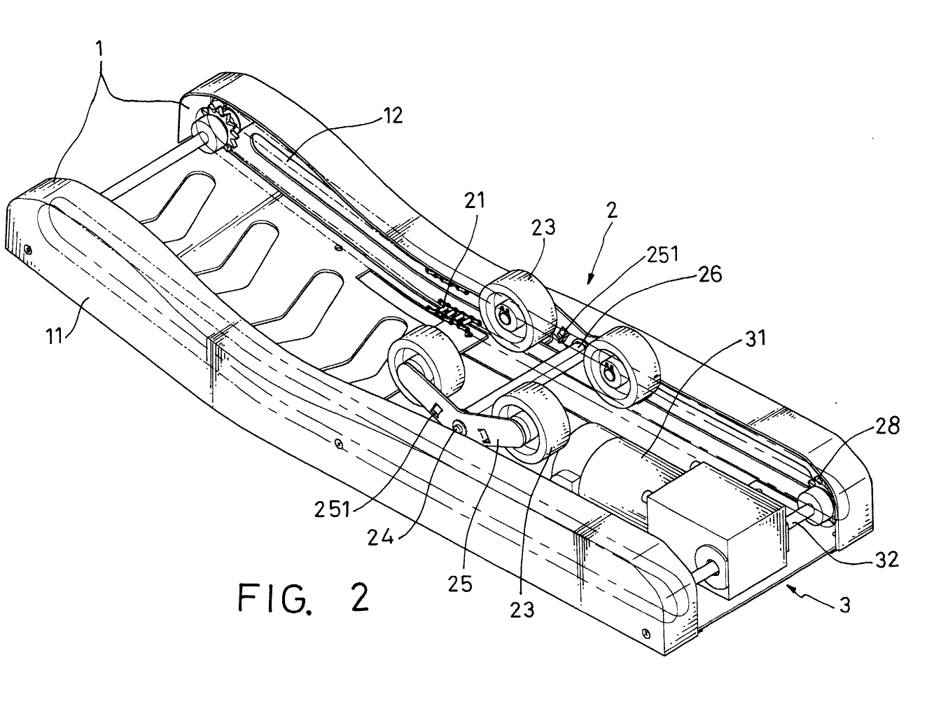

The prime mover set 3 basically is a motor 31 connecting with a power source and the output shaft of the motor 31 can drive the transmission shaft 32 via speed reducer gears and direction changing gears. The transmission shaft 32 at both ends thereof joins one of the sprockets 28 respectively such that the chain set 2 can be actuated to move forward and backward so that the motor is a bi-directional motor and can turn inversely as soon as the direction wheel touches the limit switch 13. This is conventional art so that no detail will be described further. The assembled massage apparatus of the present invention is shown in FIG. 2.

Referring to FIGS. 1 to 3 again, when the power source is on, the motor 31 starts to turn and the turning force is transmitted to the transmission shaft 32 such that the sprockets 28 are actuated to move the chains 21 together with the wheel seats 22 and the massage rollers 23. If the massage apparatus is placed on a chair against the back of a user, the user can be massaged as soon as the massage rollers move back and forth and revolve on their own axes. Because the respective arm plate 25 can move with respect to the respective spindle 24 pivotally, the massage rollers 23 can be snuggled into the back of the user so as to move along the curve of the back during the massage apparatus is in operation.

As soon as the direction wheel 27 touch the limit switch 23 disposed at an end of the massage apparatus, the motor 31 turns inversely and the sprockets 28 is actuated to move the chains backward such that the massage rollers 23 move inversely. Hence, an effect of massage can be obtained as soon as the massage rollers perform to travel back and forth.

It is appreciated from the preceding description that the present invention is a massage apparatus with high mobility. The outer casing at the top part thereof is arranged to comply with the back curve of the human body and the direction wheels can perform a curvilinear movement along curvilinear grooves to make the massage rollers keep closely contact with the back and the waist vertebra during moving back and forth. Besides, the wheel seats are disposed at a relative higher lever to pass over the prime mover set such that the wheel seat can provide a greater displacement for the massage rollers being able to extend the movement thereof to the waist vertebra. Furthermore, the casings cover the chains so as to prevent the chains from being carelessly touched by the user. It is therefore that the preceding advantages of the present invention have broken through the shortcomings resulting from the conventional massage apparatus.

While the invention has been described with reference to preferred embodiment thereof, it is to be understood that modifications or variations may be easily made without departing from the spirit of this invention, which is defined in the appended claims.

What is claimed is:

1. A massage apparatus, comprising:
an outer casing set, being two casings facing to each other, providing a curve casing wall with a longitudinal curvilinear casing groove, one of the casings at a lateral side thereof providing a limit switch at both ends thereof controlled by a circuit;
a chain set, further comprising two wheel seats, being disposed at two lateral sides of the outer casing set respectively, and being arranged at an upper level relative to the outer casing set, two endless chains, each of the endless chains fixedly joining with the respective wheel seat;
two arm plates, each of the arm plates pivotally connecting with the wheel seat via a spindle, the respective arm plate providing a stop piece to limit a pivot angle thereof;
two direction wheels, each of the direction wheels being sandwiched between an upper part and a lower part of the case wall; and
two pairs of sprockets, each pair of the sprockets meshing with the respective endless chain; and
a prime mover set, being a motor, an output of the motor transmitting to a transmission shaft via speed reducing gears and direction changing gears, and the transmission shaft at both ends thereof joining with one sprocket of each pair of the sprockets.

2. The massage apparatus according to claim 1, wherein a transverse positioning rod at both ends thereof is arranged to connect with the two roller seats.

3. The massage apparatus according to claim 1, wherein the motor is provided with variable speeds and may be turned inversely.

4. The massage apparatus according to claim 1, wherein the outer casings at a top thereof has a contour of curve.

5. The massage apparatus according to claim 1, wherein the direction wheel may turn inversely as soon as the limit is touched.
